(19) United States
(12) Patent Application Publication
(10) Pub. No.: US 2025/0156789 A1
(43) Pub. Date: May 15, 2025

(54) EVALUATION HARMONIZER

(71) Applicant: SAP SE, Walldorf (DE)

(72) Inventors: Jennifer Chen, Los Gatos, CA (US); Maria Elena Gammon, McKinney, TX (US); Shashidhar Satya Mruthyunjaya, Bangalore (IN); Mohammed Ziyauddin, Bangalore (IN); Gopal Aggarwal, Bangalore (IN); Manasa Narasegowda, Bangalore (IN); Muralikrishnamaraju Konduru, Bangalore (IN); Swathi P, Bangalore (IN)

(21) Appl. No.: 18/505,535

(22) Filed: Nov. 9, 2023

(51) Int. Cl. G06Q 10/0637; G06Q 10/0639

(52) U.S. Cl. CPC G06Q 10/0637; G06Q 10/06395

(57) ABSTRACT

In some implementations, there is a method including creating, by an evaluation harmonizer, an evaluation service by at least configuring the evaluation service to evaluate one or more entities, the configuring comprising selecting a first template and a second template; and in response to creation of the evaluation service, the method further comprises causing one or more messages to be sent to one or more evaluators; harmonizing one or more first scores and one or more second scores; and in response to the harmonizing, populating a first user interface with the one or more first scores and the one or more second scores, the first user interface generated at least in part based on the second template. Related systems, methods, and articles of manufacture are also disclosed.

### BACKGROUND

Enterprises today face challenges with respect to conducting effective evaluations of, for example, suppliers. The large number of suppliers that an enterprise uses may be in the hundreds if not thousands or even tens of thousands (if not more). Indeed, evaluating and tracking the performance of each supplier is to say the least a challenging task. Moreover, the evaluation of suppliers may require the use of disparate data sources, which may entail a labor-intensive data collection processes. For example, the information needed to evaluate a supplier may be located across multiple systems across an enterprise as well as some systems external to an enterprise. As such, enterprises may inefficiently rely on rudimentary analytical tools, such as a spreadsheet, as a primary analysis tools.

### SUMMARY

Systems, methods, and articles of manufacture, including computer program products, are provided for harmonization of evaluation data.

In some embodiments, there may be provided a system. The system may include at least one processor and at least one memory including program code which when executed by the at least one processor causes operations including creating, by an evaluation harmonizer, an evaluation service by at least configuring the evaluation service to evaluate one or more entities, the configuring comprising selecting a first template and a second template; in response to creation of the evaluation service, the operations further comprise: causing one or more messages to be sent to one or more evaluators; receiving one or more responses to the one or more messages; determining one or more first scores based on the one or more responses; obtaining one or more second scores from a database, the one or more second scores comprising one or more quantitative key indicators associated with the one or more entities; harmonizing the one or more first scores and the one or more second scores; in response to the harmonizing, populating a first user interface with the one or more first scores and the one or more second scores, the first user interface generated at least in part based on the second template; and publishing the populated first user interface to provide an evaluation of at least one of the one or more entities.

In some variations, one or more features disclosed herein can optionally be included in any feasible combination. The second template includes a scorecard template selected from a library. The first template includes a questionnaire template comprising one or more questions. The second template is linked to one or more first templates stored at a questionnaire service and is further linked to the database that stores the one or more quantitative key indicators associated with the one or more entities. The one or more entities comprise one or more suppliers. The creating further comprises selecting, via a second user interface, a name of the evaluation service, a description of the evaluation service, a type of evaluation to be performed by the evaluation service, a frequency for performing the evaluation, the one or more entities, and the one or more evaluators. The one ore more messages comprise one or more questionnaires generated at least in part based on the first template selected during the creating of the evaluation service. The harmonizing comprises normalizing the one or more first scores into a predetermined range, normalizing the one or more second scores into the predetermined range, and combining the normalized one or more first scores and the normalized one or more second scores to form a total score for an entity of the one or more entities, wherein the populated first user interface includes the total score for the entity. The harmonizing comprises receiving, at a machine learning model, the one or more first scores and the one or more second scores and outputting a plurality of scores harmonized to enable determining a total score for the plurality of scores. The machine learning model is trained to output the plurality of scores and the total score given an input of the one or more first scores and the one or more second scores. The machine learning model is trained using a generative adversarial network.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A depicts an example of a system including an evaluation harmonizer, in accordance with some embodiments;

FIG. 1B depicts an example of the evaluation harmonizer, in accordance with some embodiments;

FIG. 2A depicts an example of a user interface used to configure the evaluation harmonizer, in accordance with some embodiments;

FIG. 2B depicts another example of a user interface used to configure the evaluation harmonizer, in accordance with some embodiments;

FIG. 2C depicts an example of questionnaire templates, a scorecard template, questionnaire instances, a scorecard instance, in accordance with some embodiments;

FIG. 2D depict a user interface presenting a scorecard, in accordance with some embodiments;

FIG. 2E depicts another example of a questionnaire instance, in accordance with some embodiments;

FIG. 3A depicts an example of a process for configuring the evaluation service, in accordance with some embodiments;

FIG. 3B depicts an example of a process associated with the customer content library during questionnaire template creation, in accordance with some embodiments;

FIG. 3C depicts an example of a process for configuring the evaluation service, in accordance with some embodiments;

FIG. 3D depicts processes for handling responses to the questionnaires and obtaining scores, in accordance with some embodiments;

FIG. 3E depicts a process associated with searching for or viewing scorecards for a supplier evaluated by the evaluation harmonizer, in accordance with some embodiments; and

FIG. 4A depicts an example of a process for harmonizing, in accordance with some example embodiments.

FIG. 4B depicts a block diagram illustrating a computing system, in accordance with some example embodiments.

When practical, similar reference numbers denote similar structures, features, or elements.

### DETAILED DESCRIPTION

As noted, the evaluation of an enterprise's suppliers may be a challenging task. Supplier evaluation is further complicated by inconsistent metrics. These inconsistent metrics may be caused by differences in how different parts of an enterprise measure performance and/or metrics obtained from different data sources (some of which may be internal to the enterprise while other metrics may be external to the enterprise).

In some embodiments, there may be provided an evaluation harmonizer system (or, evaluation harmonizer, for short). The evaluation harmonizer may be configured to aggregate and harmonize evaluation data for one or more suppliers of an enterprise. The evaluation harmonizer system may also manage the processes associated with the evaluation of for example suppliers. Moreover, the evaluations may evaluate for example performance, risk, sustainability, and/or other aspects of the suppliers in a consistent way using disparate data sources.

In the case of a supplier evaluation, the processes for evaluating a supplier may use data obtained across an enterprise using, for example, a set of metrics for evaluating the performance, risk, sustainability, and/or the like associated with the suppliers. For example, the evaluation harmonizer system may collect, aggregate, and harmonize data associated with the suppliers, such as key indicator data from one or more different sources (some of which may be internal to the enterprise and/or some of which may be external to the enterprise). For example, the data associated with the suppliers may include (1) questionnaire data obtained from a set of users (“evaluators”) assessing the suppliers and (2) scorecards that combine questionnaire responses and other key indicator data to provide an evaluation of each of the suppliers, Alternatively, or additionally, the data associated with the suppliers may include other key indicator data obtained from for example databases systems (e.g., databases internal to the enterprise and/or third party databases external to the enterprise). Moreover, the evaluation harmonizer may provide visibility and transparency across different areas of an enterprise.

The key indicators may refer to data that is measurable and quantifiable, so a key indicator may serve as a metric to evaluate a supplier. For example, the key indicator may track progress towards a specific goal (e.g., objective). Some examples of key indicators are quality, sustainability, on-time delivery, and/or the like. Key indicators may be quantitative (which may be referred to as a so-called “hard” facts) or may be more qualitative (which may be referred to as a “soft” fact). To illustrate, a quantitative key indicator may be obtained from data such as transaction data (e.g., purchase orders, receipts, invoices, delivery confirmations, etc.) that may be obtained from a database, for example. A qualitative key indicator may be obtained from subjective data, such as a survey question via a questionnaire, from an evaluator (e.g., based on experience, opinion, and/or the like).

In a supplier evaluation, the process may evaluate a group of suppliers for a given period for a context, such as performance, risk, sustainability, and/or the like. The supplier evaluation outcome may be expressed as a set of metrics measured via the key indicators, which are linked to one or more dimensions, such as a purchasing category, a country code, a company code, a plant, and/or some other type of dimension. For example, the supplier X's performance score for the purchasing category “steel” in the “United States” region for the enterprise's “Automotive division” during the 2020 Q4 may be 80%. In this example, the underlined phrases correspond to the dimensions of the supplier evaluation, so the score of 80% is with respect to these dimensions. The 80% score may be mapped to a key that indicates whether the 80% score is for example excellent, good, poor, etc.

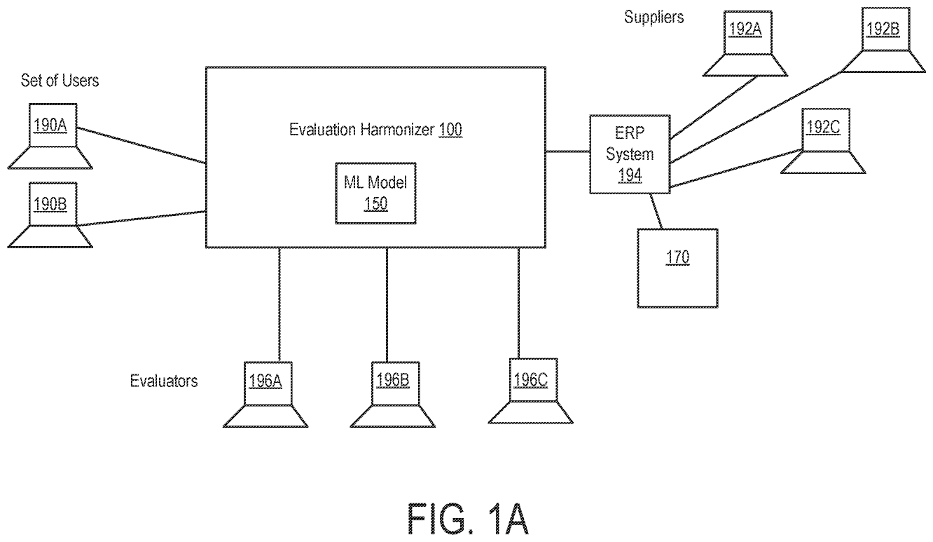

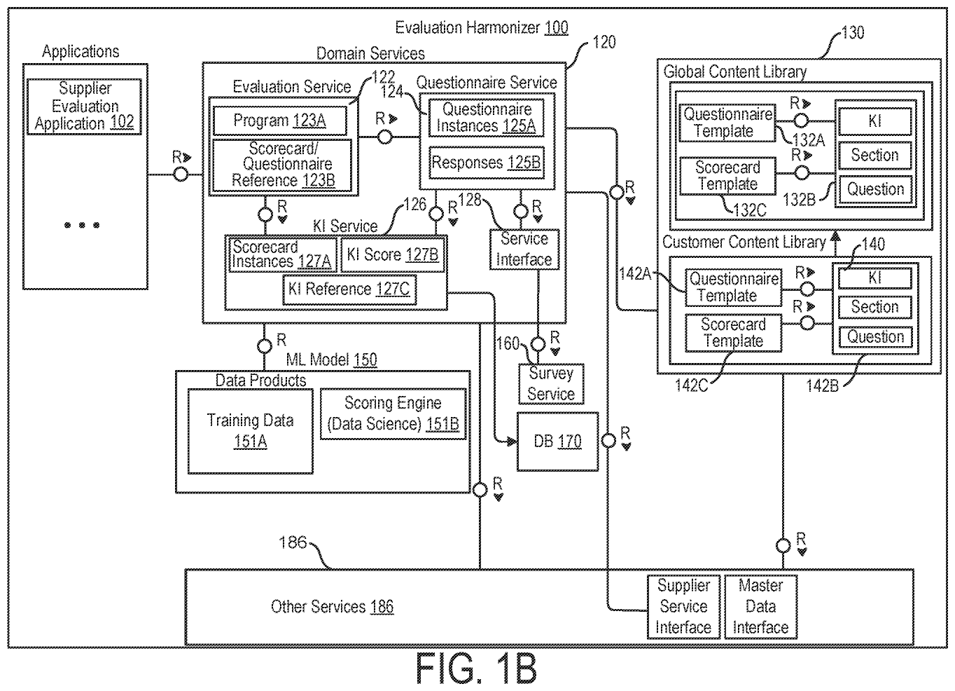

FIG. 1A depicts an example of a system including an evaluation harmonizer 100, in accordance with some embodiments. In the example of FIG. 1A, a first set of users 190A-B may couple to the evaluation harmonizer to configure the evaluation harmonizer to evaluate one or more suppliers, such as suppliers 192A-C. For example, the first set of users may include administrators or other types of users that configure one or more aspects of the evaluation harmonizer to perform supplier evaluations. The suppliers 192A-C may be entities that provide something (e.g., a product or a service) to the enterprise, and, as such, the suppliers may couple to the enterprise's enterprise resource planning (ERP) system 194 (or other type of system) to interact with the enterprise (e.g., receive orders, provide tracking information, submit invoices, and/or the like). In the example of FIG. 1A, the enterprise resource planning system 194 includes a database 170 (e.g., a database management system or other form of persistence) which may be configured as an in-memory, column store database (although other types of database technologies and/or structures may be used as well).

After the first set of users 190A-B configure the evaluation harmonizer 100 to evaluate the suppliers 192A-C, the evaluation harmonizer may obtain data associated with the suppliers by for example providing questionnaires to a second set of users such as evaluators 196A-C. The evaluators may respond to the questionnaires, and the responses may be aggregated and harmonized by the evaluation harmonizer and output to a scorecard for each of the suppliers. The scorecard may include the responses to the questionnaires and other key indicator data (which may be obtained from other data sources, such as the database 170). Moreover, the evaluation harmonizer may include a machine learning (ML) model 150 that aggregates the responses and the key indicator data to provide at least one output for a scorecard for each suppliers. The scorecard may be used to assess performance, risk, sustainability, and/or the like associated with each of the suppliers. In this way, data from disparate parts of the enterprise, different types of data (e.g., qualitative and quantitative data), as well as data from different evaluators can be aggregated and harmonized to automatically provide a scorecard on a given supplier.

FIG. 1B depicts an example of the evaluation harmonizer 100, in accordance with some embodiments. The evaluation harmonizer may include a supplier evaluation application 102, which can be accessed by, for example, one or more of the users 190A-B to configure one or more aspects of the evaluation harmonizer.

In the example of FIG. 1B, the evaluation harmonizer 100 may include domain services 120. The domain services may be coupled to a global content library 130, a customer content library 140, the ML model 150, a survey service 160, one or more external sources of data such as database 170 (e.g., a database storing key performance indicator data, evaluation data, and/or the like), and other services 186.

In the example of FIG. 1B, the domain services 120 may include an evaluation service 122, a questionnaire service 124, a KI service 126, and an interface 128 (labeled “service interface”) to the survey service 160.

The evaluation service 122 performs the evaluation of, for example, the one or more suppliers 192A-C, such that the evaluation uses data obtained from across the enterprise (which may also include external sources of data). The evaluation service (along with the ML model 150) may provide for the aggregation and harmonization of the data as part of the evaluation. Moreover, the evaluation service may be configured by the supplier evaluation application 102. As noted, one or more of the first set of users 190A-B may access the supplier evaluation application 102 to configure the evaluation service to perform the supplier evaluation.

The questionnaire service 124 includes questionnaire instances 125A that are pushed via the interface 128 to the survey service 160, which distributes the questionnaire instances to one or more users, such as one or more evaluators 196A-C. Moreover, the questionnaire service 124 includes responses 125B to the questionnaire(s). The questionnaire responses are the responses (which are generated by the one or more evaluators 196A-C) to the questionnaires. These responses are collected from the evaluators and provided to questionnaire service to form one or more responses 125B (e.g., response instances).

The questionnaire service 124 may access one or more templates in order to generate a questionnaire instance. The one or more templates may be stored in a questionnaire template store 132A at the global content library 130. To build a questionnaire instance, data 132B such as key indicator (KI) data, section data, and question data may be accessed. In the example of FIG. 1B, the questions are organized into one or more sections. For example, a section may relate to Quality of Product, and under that section there may be one or more questions, and another section may be Quality of Invoices, and under that section there may be one or more questions.

The global content library 130 may comprise a central repository for storing and maintaining templates. For example, the templates may capture best practices and/or industry standards. These global content library templates can be accessed and shared. For example, a global content library template may be stored in a customer content library and/or modified and the stored in a customer content library. For example, a template may be a supplier chain law (SCL) template, a German supply chain due diligence act template, and/or the like. In some embodiments, the global content library may be configured such that templates are read-only, so templates must be saved in another repository, such as the customer content library.

Furthermore, the questionnaire service 124 may store one or more templates in a scorecard template store 132C, which may also access the data 132B to form the scorecard template. As noted above, the questionnaire instance (as well as the questionnaire template used to form the questionnaire) may include one or more questions used to evaluate a supplier. On the other hand, the scorecard instance (and the scorecard template used to form the scorecard) may aggregate one or more questionnaires from the evaluators 196A-C and/or other data to provide a scorecard for a given supplier.

When a given user, such as user 190A, accesses supplier evaluation application 102, the supplier evaluation application is configured to allow the user to configure the supplier evaluation by, for example, creating and/or modifying a template from the global content library 130. For example, a questionnaire template from the questionnaire template store 132A or a scorecard template from the scorecard template store 132C) may be modified using the supplier evaluation application and stored and later accessed in the customer content library 140. Alternatively, or additionally, the supplier evaluation application may configure the modified template for publishing, so that other users within the enterprise (and/or outside the enterprise) can access the modified template from the global content library 130. The customer content library 140 may have a similar structure as the global content library 130. For example, one or more templates (which are modified by an end-user of supplier evaluation application 102) may be stored in a questionnaire template store 142A (or scorecard template store 142C) with access to data 142B, such as key indicator (KI) data, section data, and question data.

The customer content library 140 is a customer's central repository for scorecard and questionnaire templates. For example, a questionnaire template may include one or more sections of corresponding questions, some of which may be key indicators (so-called hard facts) while some may be responses to more qualitative questions (e.g., soft facts). The responses to the questions of a questionnaire may be collected to evaluate a supplier. The scorecard template may include key indicators generated from “soft” facts and/or “hard” facts obtained from the questionnaire responses provided by an evaluator (as well as data obtained from other sources, such as database 170 and/or the like). Moreover, weights may be defined to combine one or more different key indicators into a score or generate a weighted average to form a score. For example, a first weight may be applied to one or more responses at a questionnaire, and a second weight may be applied to a KI data obtained from a database, such as database 170. To illustrate further, a questionnaire may ask to rate the quality of a product delivered by supplier X on a scale of 1-4 (with 4 being excellent and 1 being unacceptable) and a KI for the supplier may indicate number of days a product is delivered late (e.g., after a promised or schedule delivery date). In this example, the value of “4” (excellent) and “0” (not delivered late) cannot be combined directly, but instead the two values can have weights applied to enable combining. For example, the first weight may scale the value 0-4 into a value between 0 and 100, so the 4 maps to 100. Likewise, the 0 days late is mapped to a value between 100 and 0, so zero days late would map to 100. As such, these initially different types of data have weights applied to normalize the values to allow aggregating (e.g., combining) the values to a value of 200 (which can be averaged as well to provide an output score of 100), for example. Alternatively, or additionally, the ML model 150 and/or scoring engine 151B may apply weights to normalize the scores to enable the generation of a score given the responses to questionnaires and key indicator data (which may include hard and/or soft facts). Referring to the previous example, the ML model and/or scoring engine may receive the value 4 and 0 (as well as other input data) and output a score of 100.

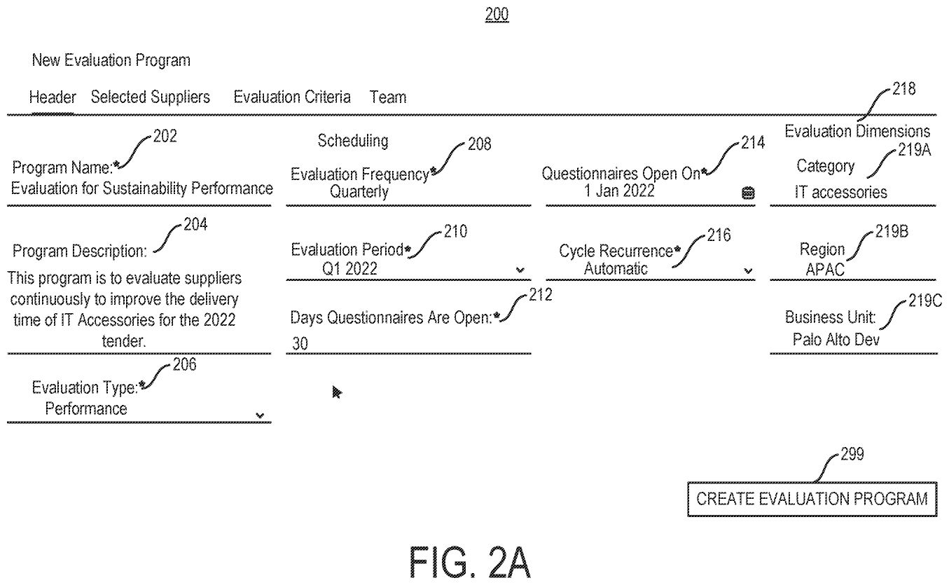

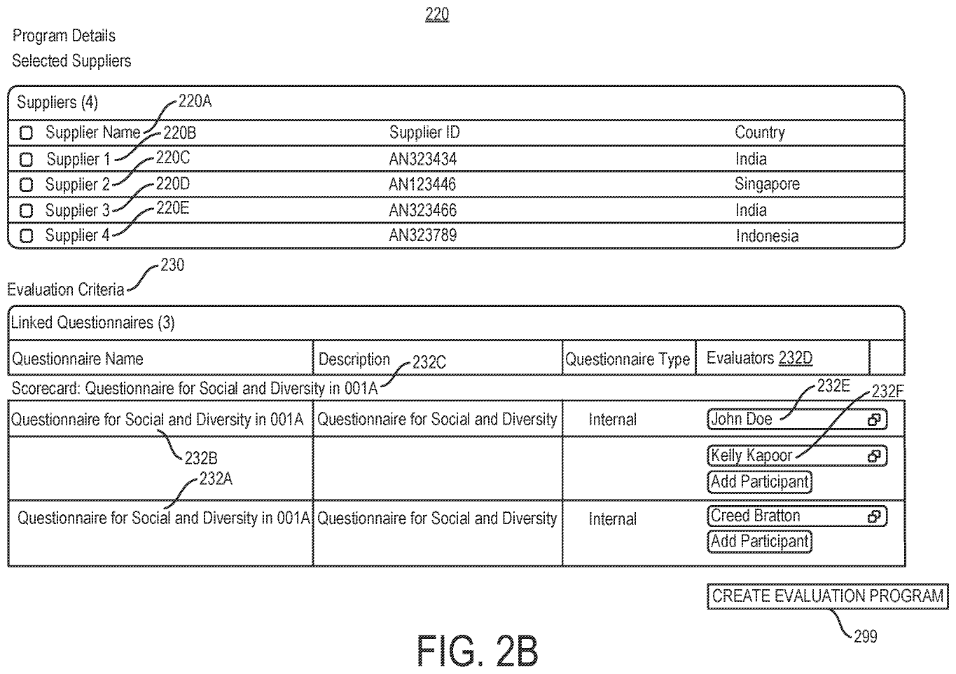

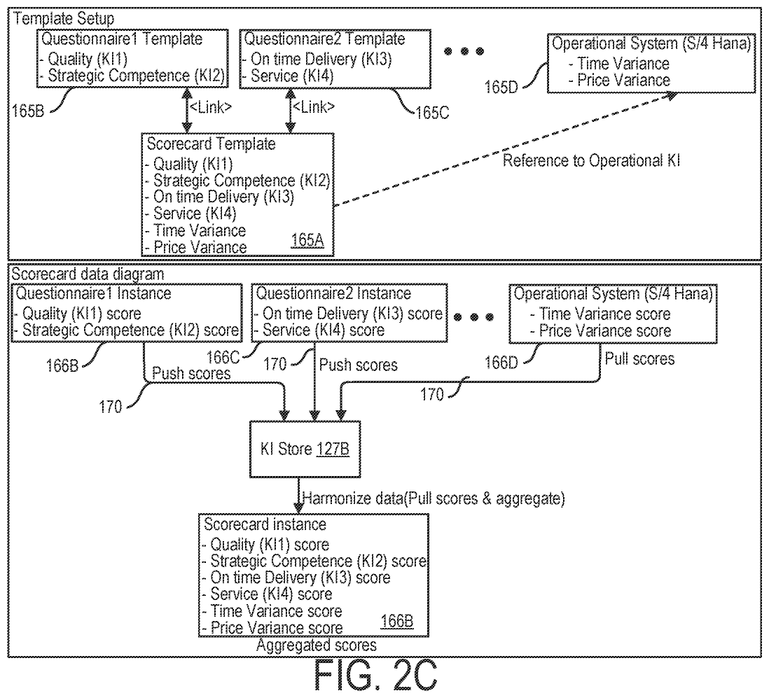

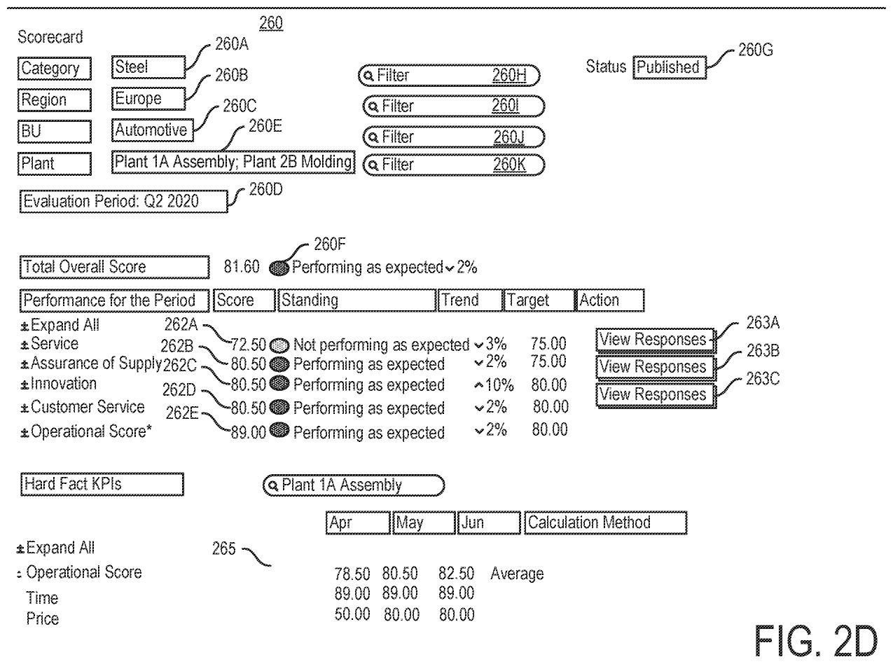

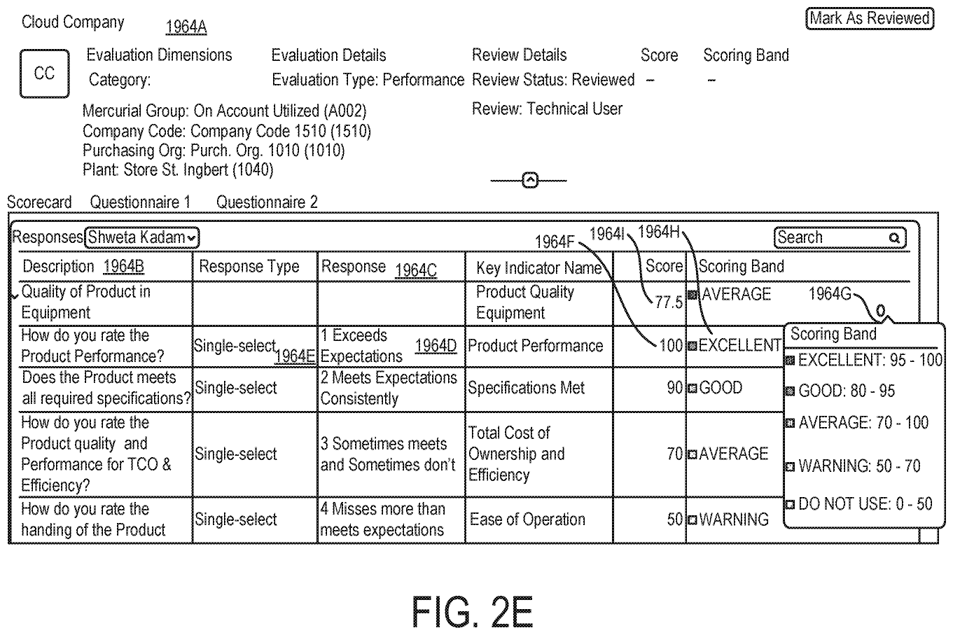

In the example of FIG. 1B, the key indicator (KI) service 126 includes scorecard instances 127A, a KI store 127B, and a KI reference 127C. For example, the KI store may generate the KI instances by, as noted, combining (e.g., aggregating and harmonizing) the plurality of responses (e.g., from questionnaires) from evaluators 196A-C as well as combining data (e.g., other hard data, such as quantitative KI data) from other sources, such as database 170 and/or the like. To illustrate further, for each supplier being evaluated, a plurality of responses to questionnaires may be received. The KI store accesses these responses to form a scorecard instance (which includes one or more evaluation scores) for each supplier. FIG. 2D (which is further described below) depicts an example of a user interface presenting a scorecard instance (or, scorecard, for short). The KI reference is a label or identifier for a given question or KI indicator data. For example, a question of a questionnaire may be “How do you rate the product performance?”, and in this example, the KI reference is an identifier or label to uniquely identify the question.

FIG. 2C depicts an example of a scorecard template 165A. In the example of FIG. 2C, the scorecard template is linked to a first questionnaire temple 165B, a second questionnaire template 165C, and KI data 165D obtained from database 170. In this example, when the first questionnaire instance 166B, the second questionnaire instance 166C (which are generated based on the respective templates 165B and 165C) are completed (e.g., by one or more evaluators 196A and so forth) and the KI data 166D is pulled (e.g., queried) from database 170, the responses in the questionnaires and the KI data are provided (e.g., pushed at 170) to the KI store 127B. Next, this data in the KI store is harmonized and aggregated to form a scorecard instance 166B (see also FIG. 2D at 260).

In the example of FIG. 1B, the domain services 120 includes, as noted, the interface 128 to the survey service 160. For example, the questionnaire instances 125A may be distributed by a survey service 160 to one or more of the evaluators 196A-C and the survey service may collect the responses (e.g., responses 125B). The evaluators may view and complete the questionnaires, and the completed questionnaires are returned as responses via the survey service. To illustrate further, the survey service may send an email (which includes the questionnaire) to evaluators across the enterprise to evaluate one or more suppliers.

The ML model 150 may include training data 151A. The training data may include responses to questionnaires (e.g., responses 125B), questionnaires (e.g., questionnaire instances 125A), examples of prior scorecards considered to an accurate assessment of a given supplier, examples of prior scorecards considered to an inaccurate assessment of a given supplier, and/or the like.

Moreover, the ML model 150 may include a scoring engine 151B. The scoring engine 151B may train, using the training data 151A, to generate a scorecard for suppliers. When trained, the ML model may receive (as an input) one or more responses 125B (e.g., responses instances) and/or other KI data to generate a scorecard for a given supplier. For example, the scoring engine may include a generative adversarial network (GAN) trained to generate scores for a given supplier. As the training uses training data (e.g., referenced data which includes scorecards considered to be accurate given an input set of questionnaire instances and KI data and inaccurate scorecards considered to be inaccurate given an input set of questionnaire instances and KI data), the scoring engine is able to combine input data from different responses (as well as other key indicator data) into a single scorecard for a given supplier.

The other services 186 may include one or more of the following: a supplier service interface to obtain information regarding an enterprise's suppliers and a master data interface to obtain data to build the templates of the global content library 130 and/or customer content library 140.

FIG. 2A depicts an example of a user interface 200 presented via access to the service evaluation application 102. In the example of FIG. 2A, a user, such as the user 190A, may configure the evaluation service 122 at least in part using the user interface 200. For example, the name of the evaluation may be selected at user interface element 202 (which in this example is “Evaluation for Sustainability Performance”). Moreover, a description of the evaluation service may be selected at user interface element 204 (which in this example is “This program is to evaluate suppliers continuously to improve delivery time of IT accessories for 2022 tender”). In addition, the type of evaluation to be performed by the evaluation service may also be selected at user interface element 206. At 206 for example, the evaluation type is selected as “Performance”, although the type may also be indicative of risk, sustainability, and/or the like.

Furthermore, the user 190A may configure the evaluation service 122 frequency (e.g., how often the supplier evaluation is performed) by the evaluation harmonizer 100. In the example of FIG. 2A, the user interface element (e.g., evaluation frequency 208) is used to select a quarterly evaluation (although the evaluation frequency may be daily, monthly, yearly, or other time periods as well). In the example of FIG. 2A, the start of the evaluation (e.g., “Q1 2022”) is selected at user interface element 210, a time period during which a given evaluator can respond to a questionnaire is selected at user interface element 212 (e.g., “30” days), a questionnaire open on date is selected at user interface element 214 to define the date on which a given evaluator can respond to a questionnaire, and a recurrence cycle for the questionnaires is selected at user interface element 216 (e.g., automatic redistribution of questionnaires and evaluation every quarter).

The user interface 200 also allows selections of the evaluation dimensions 218. The evaluation dimensions may define a type of supplier at a category user interface element (e.g., category 219A). For example, a supplier category may be selected as IT accessories, mining, or any other category defining the supplier's good or service. The evaluation dimensions may also define a geographic region for the supplier at user interface element (e.g., region 219B which in the example of FIG. 2A is Asia Pacific (APAC) although other regions may be selected as well). And, the evaluation dimensions may define a unit in the enterprise performing the supplier evaluation at a user interface element (e.g., business unit 219C which in the example of FIG. 2A is “Palo Alto Dev”).

In other words, the dimensions may represent one of the attributes of an evaluation. The attributes may include a purchasing category, a company code, a plant, material group, and/or the like. The evaluation's outcome is associated to the dimensions used. For example, a supplier X can be certified as “Qualified for Steel in North America for Sales”. In this example, the text “Steel”, “North America”, and “Sales” illustrate that supplier X is qualified only for this combination alone and may not be qualified for other combinations. In another example, if a supplier may supply steel for a line of product in US and supply steel for another line of product in Latin America, the supplier is evaluated for steel for the two lines of products in the two geographies separately, and the supplier's performance may be very good for one product line and geography but not so good in the other product line and geography.

The user interface 200 may include additional aspects to configure the evaluation service 122. In any case, when the configuration of the evaluation service is completed from the perspective of the user 190A of the supplier evaluation application 102, the user may select “create evaluation program” user interface element 299, which causes the evaluation service 122 to be configured and created such that evaluation of suppliers can begin.

FIG. 2B depicts another example of a user interface 220 presented via the service evaluation application 102 to enable configuring the evaluation service 122. In the example of FIG. 2B, a user, such as the user 190A, may configure the evaluation service 122 and, in particular, the suppliers 192A-C to be evaluated. In the example of FIG. 2B, the identities (e.g., names) of the suppliers may be presented and a selection of one or more of user interface elements 220A-E selects which suppliers will be evaluated by the evaluation service 122.

In the example of FIG. 2B, a user, such as the user 190A, may also configure the questionnaires to be used when evaluating the suppliers 192A-C. In the example of FIG. 2B, the evaluation criteria portion 230 of the user interface enables selection of one or more questionnaires, such as questionnaires 232A-B, and a selection of scorecards 232C to be used as well. In the example of FIG. 2B, the evaluators 232D within an enterprise may also be selected as 232E-F and the like. When the configuration of the evaluation service is complete from the perspective of the user 190A of the supplier evaluation application 102, the user may select the “create evaluation program” user interface element 299, which causes the evaluation service 122 to be configured and created such that supplier evaluation can begin.

FIG. 2D depicts an example of a user interface 260 presenting a scorecard. In the example of FIG. 2D, the scorecard includes information about the evaluation, such as category 260A, region 260B, business unit 260C, evaluation period 260D (as configured at FIG. 2A, for example), as well as the supplier being evaluated 260E (which in this example is Plants 1A and 2B). The scorecard also indicates whether the scorecard has been published at 260G (which in this case the scorecard has been published to the global content library). The scorecard also includes filters 260H-K which allows searching for scorecards in the repositories, such as the global content library or the customer content library.

The user interface 260 depicts a total overall score 260F for the supplier evaluation. The scorecard also lists some of the evaluation criteria. In the example of FIG. 2D, the criteria 262A-C are obtained from questionnaire response instances (which can be viewed at 263A-C, respectively) while criteria 262D-E are obtained as “hard” facts from, for example, responses to questionnaires and/or other data sources, such as database 170. The user interface also shows past scores 265 over time for the suppliers.

The user interface 260 may present a scorecard that is considered a representation of a snapshot of the performance (or, e.g., risk) of a supplier for a given period. The scorecard may thus contain the detailed scores for one or more key indicators. The weighted average of each key indicator may be rolled up (e.g., as an average, weighted score, or a ML model aggregation and harmonization) to get an overall score for a given supplier. As noted, a scorecard is generated from a scorecard template. Moreover, the scorecard may include score values (or other KI data) obtained from the KI store 127B, and these score values may be updated from time to time (e.g., in accordance with evaluation frequency 208 of FIG. 2A). When a scorecard is finalized, the scorecard may be published and made available for consumption. Moreover, the key indicator data may, as noted, be harmonized before being inserted into a scorecard. In other words, the scorecard is an object that harmonizes different key indicator data into a single evaluation of a given supplier. Harmonization may include normalizing data so that data from disparate sources is on a same scale, applying weights to certain key indicator data, and then aggregating the harmonized key indicator data into an overall score. In other words, so-call “raw data” in the KI store may be harmonized for use on the scorecard.

FIG. 2E depicts an example of a questionnaire instance 1964A with some of the questionnaire questions 1964B presented, which in this example relate to “Quality of Product in Equipment.” The evaluator, such as evaluator 196A, provided responses 1964C to each of the questions, such a response 1964D (“1. Exceeds Expectation”) to the question “How do you rate the product Performance?” 1964E. The response 1964D (e.g., (“1. Exceeds Expectation”) has a weight applied to form the score 1964F of “100,” for example. FIG. 2E also depicts a scoring band 1964G or key used to map the quantitative score 1964F into a qualitative score, such as “Excellent” 1964H.

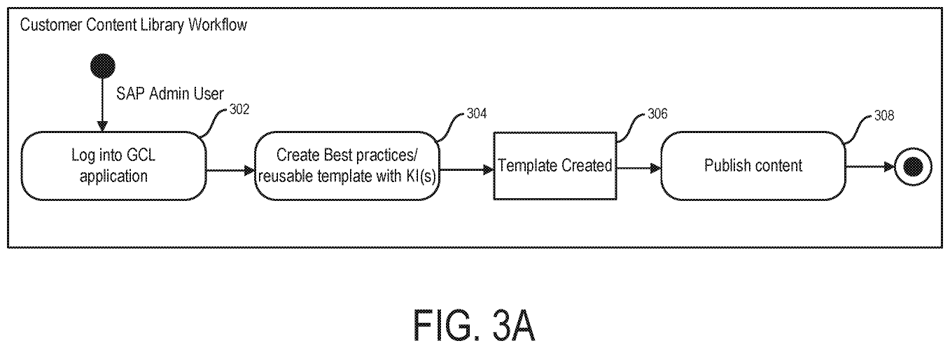

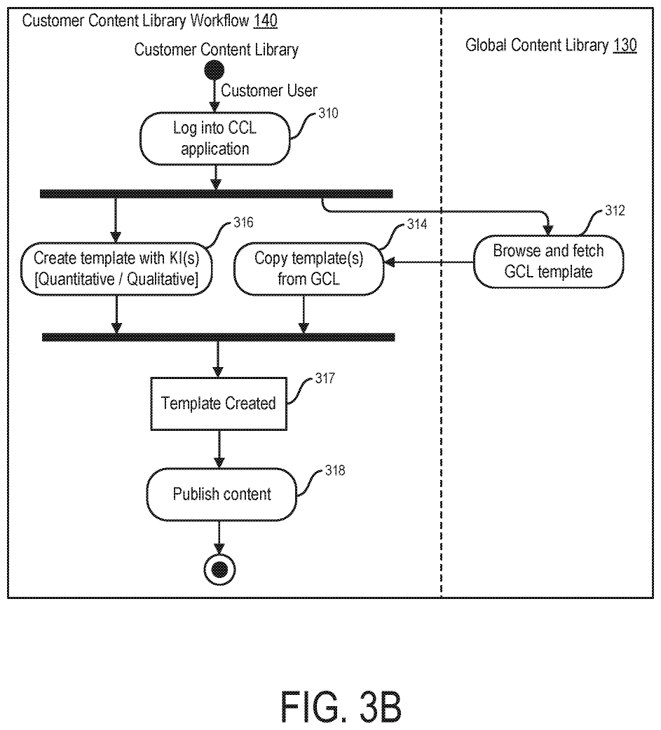

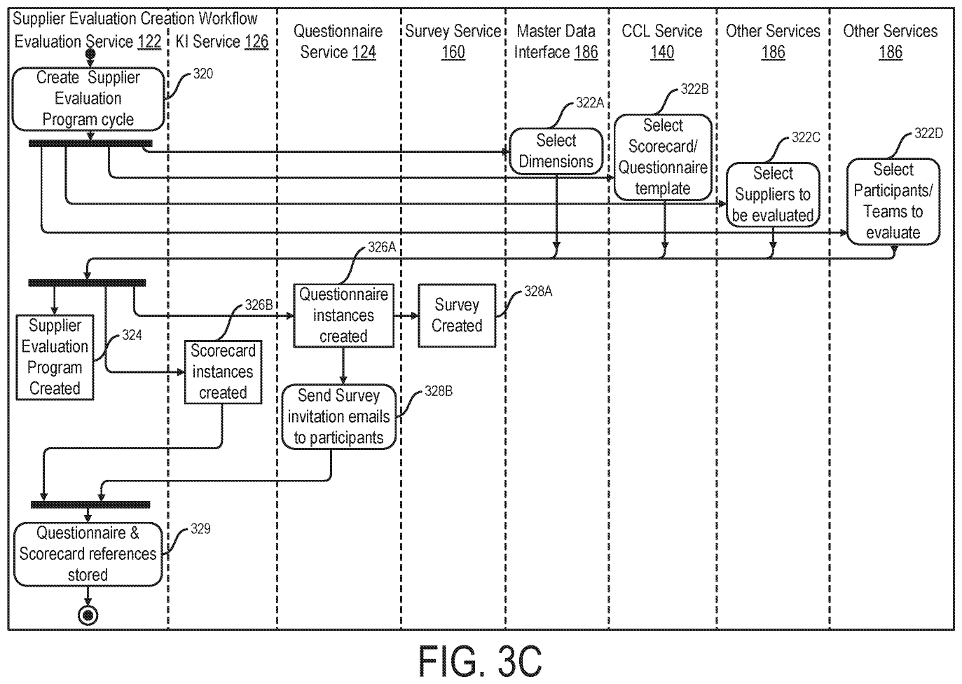

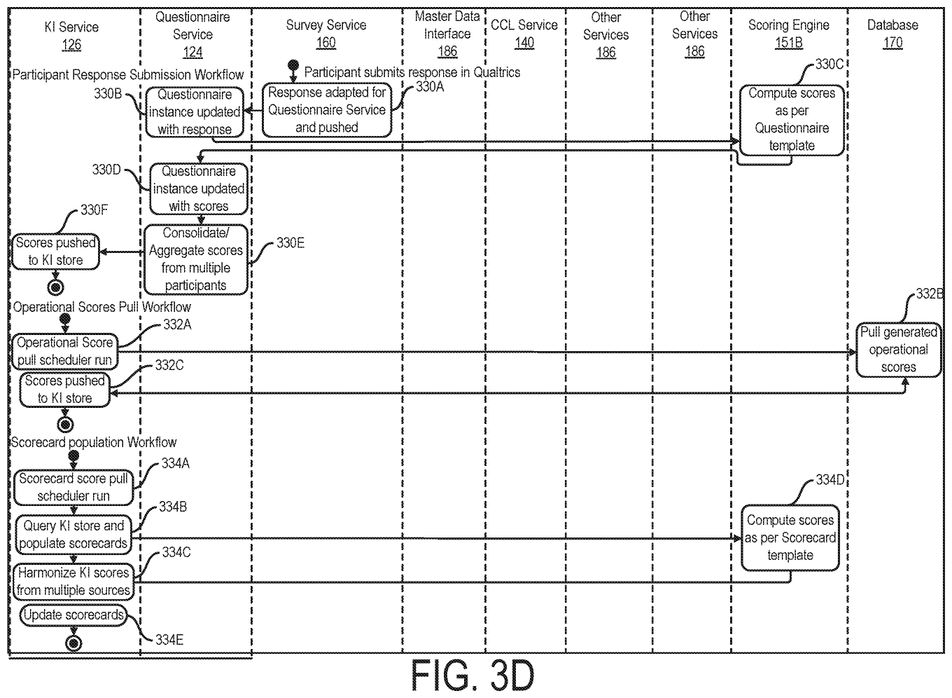

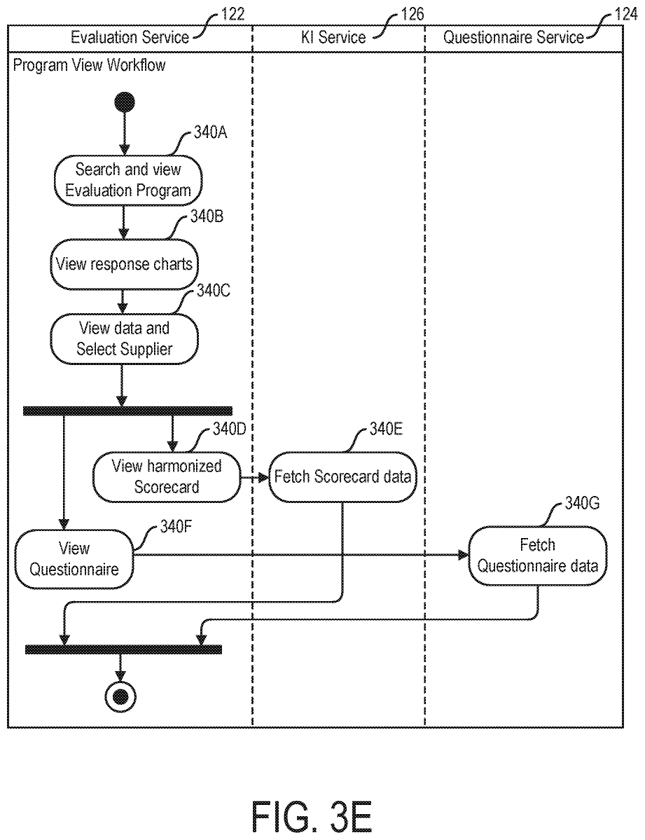

FIG. 3A depicts an example of a process for configuring the evaluation service 122. In the example of FIG. 3A, a user, such as the user 190A, may, at 302, access the supplier evaluation application 102 by logging into the supplier evaluation application 102 or accessing the global content library 130. At 304, the user may generate a questionnaire template, which is stored in questionnaire template store 132A. The questionnaire template serves as template from which a questionnaire instance can be generated. When created at 306, the questionnaire template may (at 308) be published to the global content library and/or the customer content library 140.

FIG. 3B depicts an example of a process at the customer content library 140 during questionnaire template creation. In the example of FIG. 3B, a user, such as the user 190A, may, at 310, log into the supplier evaluation application 102 or the customer content library 140. At 312, the user, such as the user 190A may select from one or more questionnaire templates from the questionnaire template store 132A at the global content library 130. At 314, the selected template(s) may be copied into the customer content library 140. The copied template may be modified as well and stored in the customer content library 140. At 316, the user may generate a questionnaire template using one or more key indicators (KI). When the questionnaire template is created at 317, the questionnaire template may at 318 be published to the customer content library 140 and/or the global content library 130.

FIG. 3C depicts an example of a process for configuring the evaluation service 122. At 320, the evaluation service 122 may access the dimensions of the evaluation. For example, the evaluation dimensions 218 of FIG. 2A may be obtained via other services 186 (e.g., using the master data interface to a master data repository or other type or repository for the ERP). For example, the categories 219A, regions 219B, and business unit 219C may be defined from a data dictionary associated with the enterprise and accessible as noted via the other services 186.

At 322B, the evaluation service 122 may access the customer content library 140 to access and obtain questionnaire template instances and/or scorecard template instances. For example, the templates and scorecards instances selected at 230, 232A-C in FIG. 2B may be retrieved from the customer content library 140 by the evaluation service 122.

At 322C, the evaluation service 122 may access a store of suppliers being used by the enterprise and selects one or more suppliers to be evaluated. For example, the suppliers selected at 220A-E may be obtained via a store accessed via other services 186 (e.g., using the master data interface to a master data repository or other type or repository for the ERP).

At 322D, the evaluation service 122 may access a store of one or more evaluators at the enterprise that will receive a questionnaire for evaluating the selected suppliers. For example, the list of evaluators selected at 232D-F may be obtained from a store via other services 186 (e.g., using the master data interface to a master data repository or other type or repository for the ERP).

Based on 322A-D, the evaluation service 122 is configured and thus created at 324 with templates so that it can perform supplier evaluations. At 326A-B, the evaluation service 122 may cause the creation of the questionnaire instances at the questionnaire services 124 and cause the creation of the scorecard instances at the KI service 126.

At 328A, the survey service 160 may distribute (e.g., via email or other medium) surveys to evaluate the suppliers 192A-C (which were selected at for example FIG. 2B). The surveys (which may include some, if not all, of a questionnaire instance for a given supplier) may be distributed, at 328B, to suppliers selected in FIG. 2B. At 329, the evaluation service 122 may cause the questionnaire and scorecards to be stored at the KI store 127B. The KI store may serve as a raw data storage of a score corresponding to a KI for a unique combination of dimensions for a particular supplier for a given period.

FIG. 3D depicts an example of a process for handling responses to the questionnaires and obtaining scores.

At 330A-B, responses to the questionnaires are processed and then stored in the questionnaire service 124. For example, the survey service 160 (which distributed the questionnaires to the suppliers) may receive responses, which may be adapted at 330A with respect to format for use by the questionnaire services 124. These responses may be associated with the corresponding questionnaire, so that the responses can be mapped to the questionnaire instances.

At 330C, the scoring engine 151B may, based on the questionnaire responses, generate scores for the scorecards. For example, the scoring engine 151B may receive (from the questionnaire service 124) a plurality of questionnaire responses for a given supplier and key indicator data (e.g., from for example a database 170) and then generate a score, such as the scores 262A-C as well as a total overall score 260F for a scorecard of the given supplier.

At 330D, the questionnaire service 124 may receive the scores from the scoring engine 151B. The received scores may be associated with the corresponding questionnaire instances (and the questionnaire responses) received for the given supplier. For example, the scores may be mapped to the questionnaire instances and responses for a given supplier.

At 330E, the questionnaire service 124 may aggregate the scores from a plurality of participants, such as responses from the evaluators 196A-C. For a given supplier for example, there may be questionnaire responses and scores from each of the evaluators. As such, the questionnaire service 124 aggregates these scores from each of the evaluators.

At 330F, the questionnaire service 120 may send the scores for a given supplier to the KI service 126 and, in particular, the KI store 127B, where the scores for a given supplier are stored.

At 332A-C, the KI service 126 may pull (e.g., retrieve, obtain, etc.) one or more scores for a given supplier from a data source, such as database 170. The database 170 may include scores and/or other key indicators for a given supplier. For example, the KI service 126 may query the database 170 for scores, such as percentage of on-time deliveries for a given supplier, and/or other key indicators (which may, as noted, be “hard” facts). At 332B, the database 170 responds with the scores for the supplier, such as the percentage of on-time deliveries, etc. At 332C, the KI service 126 may send the scores to the KI store 127B.

Once the scores are obtained, the scores may be used to populate scorecards. At 334A, the KI service 126 pulls for a given supplier one of more scores for a scorecard. As shown in the example of FIG. 2B, the scores obtained from database 170 may be used as scores at 262D-E. The score pulls may be configured to occur, one time or periodically (e.g., monthly, quarterly, annually etc.). To pull scores, the KI service may query, at 334B, the KI store 127B to populate the scorecards.

At 334C, the KI service 126 may harmonize the scores (which may be obtained from multiple sources). For a given suppliers, the scores may be obtained from different sources. As shown in the example of FIG. 2B, the scores obtained from database 170 may be used as scores at 262D-E, and the scores depicted at 262A-C may be obtained from questionnaires. As such, these scores may need to be harmonized for the scorecard (which in this example comprises normalizing the scores into a scale of 1-100%). Additionally, or alternatively, the harmonizing may include combining scores or applying a weight to a score to emphasize or deemphasize the score's impact on a supplier's overall score. The harmonizing may be performed by the ML model 150 as noted above. In some embodiments, the scoring engine 151B may harmonize the scores and compute the so-called “harmonized” scores at 334D. At 334E, the scorecard for a given supplier may be updated with the harmonized scores. The process may be repeated for each supplier, such that a scorecard (which provides an evaluation) is performed for each of the suppliers.

FIG. 3E depicts a process associated with searching for or viewing scorecards for a supplier evaluated by the evaluation harmonizer 100.

At 340A, the evaluation service 122 may search for an evaluation program 123A that performs (or performed) an evaluation of one or more suppliers to enable viewing the corresponding program 123A and the scorecard associated with each of the suppliers. For example, the supplier evaluation application 102 may be accessed to search for the evaluation program 123A that performs (or performed) the evaluation of one or more suppliers. At 340B-C, the evaluation service 122 may then be used to view responses to the questionnaires as well as data for a given supplier. Likewise, the evaluation service may, at 340D, access and view harmonized scorecards, such as the scorecard depicted at FIG. 2D. When that is the case, the evaluation service 122 may, at 340E, fetch from the KI service 126 the harmonized scorecard. In the case of viewing a scorecard, the evaluation service 122 may, at 340F-G, also view the corresponding questionnaire (and/or responses) for the scorecard by fetched such data from the questionnaire service 124.

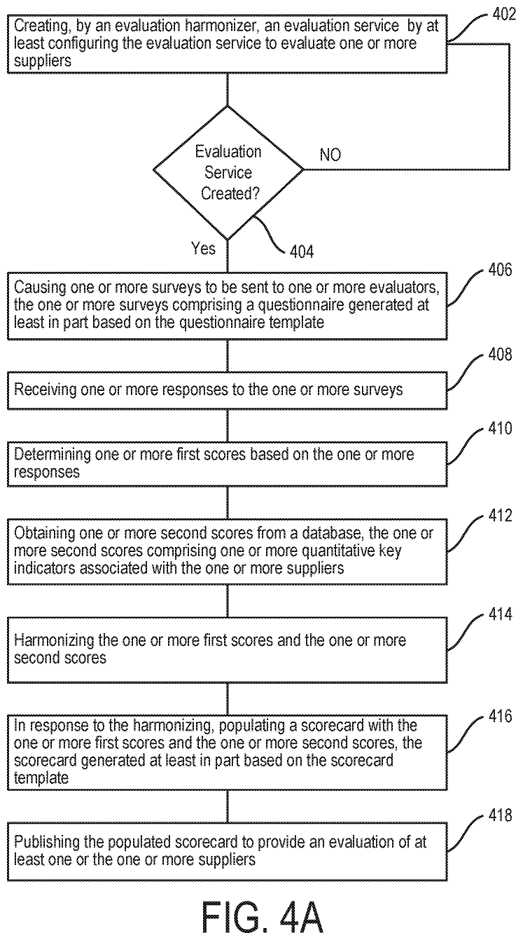

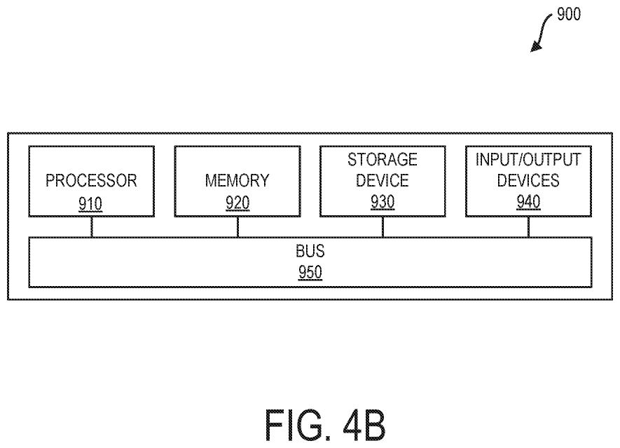

FIG. 4A depicts an example of a process for harmonizing different type of data from different sources of data to evaluate an entity such as a supplier, in accordance with some example embodiments.

At 402, an evaluation harmonizer, such as evaluation harmonizer 100, may create an evaluation service, such as evaluation service 122. For example, the evaluation service may be created by at least configuring the evaluation service such that it can evaluate one or more entities (e.g., suppliers, such as suppliers 192A-C). This configuring may include selecting a first template, such as a questionnaire template, and a second template, such as a scorecard template. For example, the questionnaire template may be selected from the global content library 130 and/or the customer content library 140. Moreover, one or more aspects of the process noted above with respond to FIG. 3C may also be used to configure the evaluation service.

In response to the evaluation service being created (Yes at 404), one or more messages (e.g., surveys) may be caused to be sent to one or more evaluators at 406. For example, the selected questionnaire template may be used to form a questionnaire instance (or questionnaire, for short). The evaluation service may cause the survey service 160 to be sent to one or more evaluators 196A-C. To illustrate further, the questionnaire instances 125A may be distributed by the survey service 160 to one or more of the evaluators 196A-C and collect the responses 125B.

At 408, one or more responses to the one or more messages, such as surveys, may be received. For example, the surveys (which comprise the selected questionnaire) may be completed by a corresponding evaluator 196A-C and returned to the evaluation service 122 at the evaluation harmonizer 100 via the survey service 160.

At 410, the evaluation service may determine one or more first scores based on the one or more responses. Referring to FIG. 2E, the evaluation service 122 may receive responses 1964C from at least one evaluator and determine a score from a corresponding response. In the example of FIG. 2E, the response “1. Exceeds Expectations” is scored as “100” 1964F.

At 412, the evaluation service may determine one or more second scores from a database, the one or more second scores comprising quantitative key indicators associated with the one or more suppliers. Referring to FIG. 2C, the evaluation service 122 may receive from the database 170 a data value for Time Variance (e.g., a variance in a supplier's delivery time, so a smaller variance would represent a more consistent delivery time) and a data value for Price Variance (e.g., a variance in a supplier's price, so a smaller variance would represent a more consistent price). These data values may each be mapped to a score.

At 414, the evaluation service may harmonize the one or more first scores and the one or more second scores. For example, the evaluation service (and/or the machine learning model 150) may receive the first scores (which may be considered “soft” fact data from responses to the questionnaire) and may receive the second scores (which may be considered “hard” fact data from the database 170) and then apply one or more weights to the scores such that the scores can be normalized and combined into an overall score for the supplier being evaluated. To illustrate further, the harmonizing may normalize the first scores into a predetermined range. In the example of FIG. 2E, the first scores are normalized (e.g., using a weight) into a predetermined range of 0-100 (although other predetermined ranges may be used as well). Likewise, the second scores may be normalized into a predetermined range. Referring to FIG. 2D for example, the second score 262E is normalized into a predetermined range, which again is a predetermined range of 0-100 (although other predetermined ranges may be used as well). This normalizing allows the first and second scores to be combined into a total score, such as total overall score 260F for a given supplier. The harmonizing may also allow the one or more first scores to be combined (e.g., averaged, added, and/or the like). For example, the scores 1964I, 1964F, and so forth may be aggregated into a score for the “Quality of Product in Equipment” and across different responses from different evaluators.

In response to the harmonizing, the evaluation service may populate, at 416, a first user interface, such as a scorecard, with the one or more first scores and the one or more second scores. Referring to FIG. 2C again, the harmonized scores from the KI store 127B are pushed to a scorecard instance, such as scorecard instance 166B. FIG. 2D also depicts an example of a populated scorecard instance as well. As noted, the scorecard instance is generated at least in part based on the scorecard template configured at 402, for example.

At 418, the populated scorecard may be published to provide an evaluation of at least one or the one or more entities, such as suppliers. For example, the evaluation service may generate the user interface of FIG. 2D and push that to one or more client devices to depict the evaluation of a given supplier.

In some implementations, the process described with respect to FIG. 4B may reduce the processing and computing resources related to evaluating entities, such as suppliers. For example, the automated evaluation harmonization may leverage machine learning and templates to compile an evaluation of an entity using disparate data from across the enterprise using a single, consistent process (which saves memory, bandwidth, and processor resources).

FIG. 4B depicts a block diagram illustrating a computing system 900, in accordance with some example embodiments. Referring to FIGS. 1-4A, the computing system 900 can be used to implement the evaluation harmonizer 100 and/or any components therein.

As shown in FIG. 4B, the computing system 900 can include a processor 910, a memory 920, a storage device 930, and an input/output device 940. The processor 910, the memory 920, the storage device 930, and the input/output device 940 can be interconnected via a system bus 950. The processor 910 is capable of processing instructions for execution within the computing system 900. Such executed instructions can implement one or more components of, for example, the evaluation harmonizer 100 or other devices disclosed herein. In some implementations of the current subject matter, the processor 910 can be a single-threaded processor. Alternately, the processor 910 can be a multi-threaded processor. The processor 910 is capable of processing instructions stored in the memory 920 and/or on the storage device 930 to display graphical information for a user interface provided via the input/output device 940.

The memory 920 is a computer readable medium such as volatile or non-volatile that stores information within the computing system 900. The memory 920 can store data structures representing configuration object databases, for example. The storage device 930 is capable of providing persistent storage for the computing system 900. The storage device 930 can be a floppy disk device, a hard disk device, an optical disk device, or a tape device, or other suitable persistent storage means. The input/output device 940 provides input/output operations for the computing system 900. In some implementations of the current subject matter, the input/output device 940 includes a keyboard and/or pointing device. In various implementations, the input/output device 940 includes a display unit for displaying graphical user interfaces.

According to some implementations of the current subject matter, the input/output device 940 can provide input/output operations for a network device. For example, the input/output device 940 can include Ethernet ports or other networking ports to communicate with one or more wired and/or wireless networks (e.g., a local area network (LAN), a wide area network (WAN), the Internet).

In some implementations of the current subject matter, the computing system 900 can be used to execute various interactive computer software applications that can be used for organization, analysis and/or storage of data in various (e.g., tabular) format (e.g., Microsoft Excel®, and/or any other type of software). Alternatively, the computing system 900 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 940. The user interface can be generated and presented to a user by the computing system 900 (e.g., on a computer screen monitor, etc.).

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A system, comprising:
at least one processor; and
at least one memory including program code which when executed by the at least one processor provides operations comprising:
   creating, by an evaluation harmonizer, an evaluation service by at least configuring the evaluation service to evaluate one or more entities, the configuring comprising selecting a first template and a second template;
   in response to creation of the evaluation service, the operations further comprise:
      causing one or more messages to be sent to one or more evaluators;
      receiving one or more responses to the one or more messages;
      determining one or more first scores based on the one or more responses;
      obtaining one or more second scores from a database, the one or more second scores comprising one or more quantitative key indicators associated with the one or more entities;
      harmonizing the one or more first scores and the one or more second scores;
      in response to the harmonizing, populating a first user interface with the one or more first scores and the one or more second scores, the first user interface generated at least in part based on the second template; and publishing the populated first user interface to provide an evaluation of at least one of the one or more entities.

Example 2: The system of Example 1, wherein the second template comprises a scorecard template selected from a library.

Example 3: The system of any of Examples 1-2, wherein the first template comprises a questionnaire template comprising one or more questions, and wherein the second template is linked to one or more first templates stored at a questionnaire service and is further linked to the database that stores the one or more quantitative key indicators associated with the one or more entities, wherein the one or more entities comprise one or more suppliers.

Example 4: The system of any of Examples 1-3, wherein the creating further comprises selecting, via a second user interface, a name of the evaluation service, a description of the evaluation service, a type of evaluation to be performed by the evaluation service, a frequency for performing the evaluation, the one or more entities, and the one or more evaluators.

Example 5: The system of any of Examples 1-4, wherein the one ore more messages comprise one or more questionnaires generated at least in part based on the first template selected during the creating of the evaluation service.

Example 6: The system of any of Examples 1-5, wherein the harmonizing comprises normalizing the one or more first scores into a predetermined range, normalizing the one or more second scores into the predetermined range, and combining the normalized one or more first scores and the normalized one or more second scores to form a total score for an entity of the one or more entities, wherein the populated first user interface includes the total score for the entity.

Example 7: The system of any of Examples 1-6, wherein the harmonizing comprises receiving, at a machine learning model, the one or more first scores and the one or more second scores and outputting a plurality of scores harmonized to enable determining a total score for the plurality of scores.

Example 8: The system of any of Examples 1-7, wherein the machine learning model is trained to output the plurality of scores and the total score given an input of the one or more first scores and the one or more second scores.

Example 9: The system of any of Examples 1-8, wherein the machine learning model is trained using a generative adversarial network.

Example 10: A method comprising:
creating, by an evaluation harmonizer, an evaluation service by at least configuring the evaluation service to evaluate one or more entities, the configuring comprising selecting a first template and a second template;
in response to creation of the evaluation service, the method further comprises:
   causing one or more messages to be sent to one or more evaluators;
   receiving one or more responses to the one or more messages;
   determining one or more first scores based on the one or more responses;
   obtaining one or more second scores from a database, the one or more second scores comprising one or more quantitative key indicators associated with the one or more entities;
   harmonizing the one or more first scores and the one or more second scores;
   in response to the harmonizing, populating a first user interface with the one or more first scores and the one or more second scores, the first user interface generated at least in part based on the second template; and
   publishing the populated first user interface to provide an evaluation of at least one of the one or more entities.

Example 11: The method of Example 10, wherein the second template comprises a scorecard template selected from a library.

Example 12: The method of any of Examples 10-11, wherein the first template comprises a questionnaire template comprising one or more questions, and wherein the second template is linked to one or more first templates stored at a questionnaire service and is further linked to the database that stores the one or more quantitative key indicators associated with the one or more entities, wherein the one or more entities comprise one or more suppliers.

Example 13: The method of any of Examples 10-12, wherein the creating further comprises selecting, via a second user interface, a name of the evaluation service, a description of the evaluation service, a type of evaluation to be performed by the evaluation service, a frequency for performing the evaluation, the one or more entities, and the one or more evaluators.

Example 14: The method of any of Examples 10-13, wherein the one ore more messages comprise one or more questionnaires generated at least in part based on the first template selected during the creating of the evaluation service.

Example 15: The method of any of Examples 10-14, wherein the harmonizing comprises normalizing the one or more first scores into a predetermined range, normalizing the one or more second scores into the predetermined range, and combining the normalized one or more first scores and the normalized one or more second scores to form a total score for an entity of the one or more entities, wherein the populated first user interface includes the total score for the entity.

Example 16: The method of any of Examples 10-15, wherein the harmonizing comprises receiving, at a machine learning model, the one or more first scores and the one or more second scores and outputting a plurality of scores harmonized to enable determining a total score for the plurality of scores.

Example 17: The method of any of Examples 10-16, wherein the machine learning model is trained to output the plurality of scores and the total score given an input of the one or more first scores and the one or more second scores.

Example 18: The method of any of Examples 10-17, wherein the machine learning model is trained using a generative adversarial network.

Example. 19: A non-transitory computer-readable storage medium including program code which when executed by the at least one processor causes operations comprising:
creating, by an evaluation harmonizer, an evaluation service by at least configuring the evaluation service to evaluate one or more entities, the configuring comprising selecting a first template and a second template;
in response to creation of the evaluation service, the operations further comprise:
   causing one or more messages to be sent to one or more evaluators;
   receiving one or more responses to the one or more messages;
   determining one or more first scores based on the one or more responses;
   obtaining one or more second scores from a database, the one or more second scores comprising one or more quantitative key indicators associated with the one or more entities;
   harmonizing the one or more first scores and the one or more second scores;
   in response to the harmonizing, populating a first user interface with the one or more first scores and the one or more second scores, the first user interface generated at least in part based on the second template; and
   publishing the populated first user interface to provide an evaluation of at least one of the one or more entities.

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A system, comprising:
at least one processor; and
at least one memory including program code which when executed by the at least one processor causes operations comprising:
creating, by an evaluation harmonizer, an evaluation service by at least configuring the evaluation service to evaluate one or more entities, the configuring comprising selecting a first template and a second template;
in response to creation of the evaluation service, the operations further comprise:
causing one or more messages to be sent to one or more evaluators;
receiving one or more responses to the one or more messages;
determining one or more first scores based on the one or more responses;
obtaining one or more second scores from a database, the one or more second scores comprising one or more quantitative key indicators associated with the one or more entities;
harmonizing the one or more first scores and the one or more second scores;
in response to the harmonizing, populating a first user interface with the one or more first scores and the one or more second scores, the first user interface generated at least in part based on the second template; and
publishing the populated first user interface to provide an evaluation of at least one of the one or more entities.

2. The system of claim 1, wherein the second template comprises a scorecard template selected from a library.

3. The system of claim 1, wherein the first template comprises a questionnaire template comprising one or more questions, and wherein the second template is linked to one or more first templates stored at a questionnaire service and is further linked to the database that stores the one or more quantitative key indicators associated with the one or more entities, wherein the one or more entities comprise one or more suppliers.

4. The system of claim 1, wherein the creating further comprises selecting, via a second user interface, a name of the evaluation service, a description of the evaluation service, a type of evaluation to be performed by the evaluation service, a frequency for performing the evaluation, the one or more entities, and the one or more evaluators.

5. The system of claim 1, wherein the one ore more messages comprise one or more questionnaires generated at least in part based on the first template selected during the creating of the evaluation service.

6. The system of claim 1, wherein the harmonizing comprises normalizing the one or more first scores into a predetermined range, normalizing the one or more second scores into the predetermined range, and combining the normalized one or more first scores and the normalized one or more second scores to form a total score for an entity of the one or more entities, wherein the populated first user interface includes the total score for the entity.

7. The system of claim 1, wherein the harmonizing comprises receiving, at a machine learning model, the one or more first scores and the one or more second scores and outputting a plurality of scores harmonized to enable determining a total score for the plurality of scores.

8. The system of claim 7, wherein the machine learning model is trained to output the plurality of scores and the total score given an input of the one or more first scores and the one or more second scores.

9. The system of claim 8, wherein the machine learning model is trained using a generative adversarial network.

10. A method comprising:
creating, by an evaluation harmonizer, an evaluation service by at least configuring the evaluation service to evaluate one or more entities, the configuring comprising selecting a first template and a second template;
in response to creation of the evaluation service, the method further comprises:
causing one or more messages to be sent to one or more evaluators;
receiving one or more responses to the one or more messages;
determining one or more first scores based on the one or more responses;
obtaining one or more second scores from a database, the one or more second scores comprising one or more quantitative key indicators associated with the one or more entities;
harmonizing the one or more first scores and the one or more second scores;
in response to the harmonizing, populating a first user interface with the one or more first scores and the one or more second scores, the first user interface generated at least in part based on the second template; and
publishing the populated first user interface to provide an evaluation of at least one of the one or more entities.

11. The method of claim 10, wherein the second template comprises a scorecard template selected from a library.

12. The method of claim 10, wherein the first template comprises a questionnaire template comprising one or more questions, and wherein the second template is linked to one or more first templates stored at a questionnaire service and is further linked to the database that stores the one or more quantitative key indicators associated with the one or more entities, wherein the one or more entities comprise one or more suppliers.

13. The method of claim 10, wherein the creating further comprises selecting, via a second user interface, a name of the evaluation service, a description of the evaluation service, a type of evaluation to be performed by the evaluation service, a frequency for performing the evaluation, the one or more entities, and the one or more evaluators.

14. The method of claim 10, wherein the one ore more messages comprise one or moere questionnaires generated at least in part based on the first template selected during the creating of the evaluation service.

15. The method of claim 10, wherein the harmonizing comprises normalizing the one or more first scores into a predetermined range, normalizing the one or more second scores into the predetermined range, and combining the normalized one or more first scores and the normalized one or more second scores to form a total score for an entity of the one or more entities, wherein the populated first user interface includes the total score for the entity.

16. The method of claim 10, wherein the harmonizing comprises receiving, at a machine learning model, the one or more first scores and the one or more second scores and outputting a plurality of scores harmonized to enable determining a total score for the plurality of scores.

17. The method of claim 16, wherein the machine learning model is trained to output the plurality of scores and the total score given an input of the one or more first scores and the one or more second scores.

18. The method of claim 17, wherein the machine learning model is trained using a generative adversarial network.

19. A non-transitory computer-readable storage medium including program code which when executed by the at least one processor causes operations comprising:
creating, by an evaluation harmonizer, an evaluation service by at least configuring the evaluation service to evaluate one or more entities, the configuring comprising selecting a first template and a second template;
in response to creation of the evaluation service, the operations further comprise:
causing one or more messages to be sent to one or more evaluators;
receiving one or more responses to the one or more messages;
determining one or more first scores based on the one or more responses;
obtaining one or more second scores from a database, the one or more second scores comprising one or more quantitative key indicators associated with the one or more entities;
harmonizing the one or more first scores and the one or more second scores;
in response to the harmonizing, populating a first user interface with the one or more first scores and the one or more second scores, the first user interface generated at least in part based on the second template; and
publishing the populated first user interface to provide an evaluation of at least one of the one or more entities.
